(19) United States
(12) Patent Application Publication
(10) Pub. No.: US 2014/0300439 A1
(43) Pub. Date: Oct. 9, 2014

(54) WIRE ROD FOR INDUCTOR, AND INDUCTOR

(71) Applicants: Furukawa Magnet Wire Co., Ltd., Tokyo (JP); Furukawa Electric Co., Ltd., Tokyo (JP)

(72) Inventors: Kengo TANAKA, Tokyo (JP); Noriyoshi Fushimi, Tokyo (JP); Fumihiko Abe, Tokyo (JP)

(73) Assignees: Furukawa Magnet Wire Co., Ltd., Tokyo (JP); Furukawa Electric Co., Ltd., Tokyo (JP)

(21) Appl. No.: 14/244,512

(22) Filed: Apr. 3, 2014

Related U.S. Application Data
(63) Continuation of application No. PCT/JP2011/072829, filed on Oct. 4, 2011.

(51) Int. Cl. H01F 27/28

(52) U.S. Cl. CPC H01F 27/2823
USPC 336/177

(57) ABSTRACT

A wire rod for inductor used for a coil of an inductor includes an electric conductor and a magnetic layer made of Fe that is provided on a surface of the electric conductor. The magnetic layer has a thickness of greater than 0 μm and less than or equal to 3.0 μm.

### CROSS REFERENCE TO RELATED APPLICATIONS

This is a continuation application of International Patent Application No. PCT/JP2011/072829 filed Oct. 4, 2011, the full content of which is hereby incorporated by reference in their entirety.

### BACKGROUND

1. Technical Field

The present disclosure relates to a wire rod for inductor used for a winding of an inductor, and an inductor using such a wire rod.

2. Background Art

As a wire rod for windings for manufacturing an inductor, a wire rod having an insulating layer provided outwardly of an electrical conductor such as copper is commonly used.

Wire rods having a magnetic material plated on a surface of such an electrical conductor are also known. It has been disclosed that, with an inductor using such a wire rod, in a 1 MHz frequency band, there is an effect of increasing an inductance by approximately 10% (e.g., see Japanese Laid-open Patent Publication No. S62-211904).

The quality of an inductor is generally expressed by a Q factor (Q factor=2π×frequency×inductance Ls/wire-wound resistance Rs) being high. In the aforementioned document, it is described that an inductance L increases, but its relationship with respect to a resistance value R is not known. Also, in the aforementioned document, a relationship with respect to a material or a thickness of the magnetic layer is not described. On the other hand, regarding a resonant circuit disclosed in the document, it is described that the Q factor is lowered, but there is no description about increasing the Q factor (i.e., lowering a resistance value).

It is an object of the present disclosure to provide, by taking the aforementioned background art into consideration, a wire rod for inductor and an inductor that can improve a Q factor by further taking a resistance value into account when providing a magnetic layer on a surface of the electrical conductor.

### SUMMARY

In order to achieve the above mentioned object, according to the present disclosure, a wire rod for inductor used for a coil of an inductor includes an electric conductor and a magnetic layer provided on a surface of the electric conductor, and the magnetic layer has a thickness of greater than 0 μm and less than or equal to 3.0 μm.

Preferably, when a usable frequency band is greater than or equal to 0.01 kHz and less than or equal to 1,000 kHz, the magnetic layer has an initial permeability of 100 to 500 expressed as a relative permeability and has a thickness of greater than 0 μm and less than or equal to 3.0 μm.

More preferably, when a usable frequency band is greater than or equal to 0.01 kHz and less than or equal to 5,000 kHz, the magnetic layer has an initial permeability of 100 to 500 expressed as a relative permeability and has a thickness of greater than 0 μm and less than or equal to 2.0 μm.

More preferably, when a usable frequency band is greater than or equal to 0.01 kHz and less than or equal to 1,000 kHz, the magnetic layer has an initial permeability of 500 to 2,000 expressed as a relative permeability and has a thickness of greater than 0 μm and less than or equal to 2.5 μm.

More preferably, when a usable frequency band is greater than or equal to 0.01 kHz and less than or equal to 1,000 kHz, the magnetic layer has an initial permeability of 500 to 2,000 expressed as a relative permeability and has a thickness of greater than 0 μm and less than or equal to 2.0 μm.

More preferably, when a usable frequency band is greater than or equal to 0.01 kHz and less than or equal to 5,000 kHz, the magnetic layer has an initial permeability of 500 to 2,000 expressed as a relative permeability and has a thickness of greater than or equal to 0.5 μm and less than or equal to 1.5 μm.

More preferably, the magnetic layer may be an alloy of two or more elements containing Fe of greater than or equal to 10% by weight.

Further, the magnetic layer may be made of an Fe-50Ni alloy.

Further, the magnetic layer may be made of an Fe-80Ni alloy.

Further, wherein the magnetic layer may be made of substantially Fe.

Further, the magnetic layer may have a thickness of greater than 0 μm and less than or equal to 3.0 μm, and more preferably, the magnetic layer has a thickness of greater than or equal to 1.5 μm and less than or equal to 3.0 μm.

In the above cases, the magnetic layer may be provided between the electric conductor and an insulating layer.

On the other hand, an inductor may be manufactured using the aforementioned wire rod.

According to a wire rod for inductor of the present disclosure, a wire rod for inductor used for a coil of an inductor, includes an electric conductor; and a magnetic layer that is provided on a surface of the electric conductor and the magnetic layer has a thickness of greater than 0 μm and less than or equal to 3.0 μm. That is to say, since a magnetic layer of the predetermined thickness is provided on a surface of an electric conductor, an inductance can be improved while decreasing a resistance value and increasing a Q factor, as compared to a wire rod that is not provided with a magnetic layer.

### BRIEF DESCRIPTION OF DRAWINGS

FIG. 1 is a cross-sectional view schematically showing a configuration of a wire rod for inductor of a first embodiment of the present disclosure.

FIGS. 2A and 2B are cross-sectional views of a wire rod for inductor for a case where a flat rectangular wire is used.

FIG. 3 is a cross-sectional view of an air core coil using a wire rod for inductor.

FIG. 4 is a graph showing a relationship between a frequency and an inductance of an air core coil.

FIG. 5 is a graph showing a relationship between a frequency and a rate of change of inductance of an air core coil.

FIG. 6 is graph showing a relationship between a thickness of plating and a rate of change of inductance for a case where an Fe alloy was used as a magnetic layer.

FIG. 7 is a graph showing a relationship between a thickness of plating and a rate of change of resistance for a case where an Fe alloy was used as a magnetic layer.

FIG. 8 is a graph showing a relationship between a thickness of plating and a rate of change of Q factor for a case where an Fe alloy was used as a magnetic layer.

FIG. 9 is a graph showing a relationship between a thickness of plating and a rate of change of inductance for a case where an Fe-80Ni alloy was used as a magnetic layer.

FIG. 10 is a graph showing a relationship between a thickness of plating and a rate of change of resistance for a case where an Fe-80Ni alloy was used as a magnetic layer.

FIG. 11 is a graph showing a relationship between a thickness of plating and a rate of change of Q factor for a case where an Fe-80Ni alloy was used as a magnetic layer.

FIG. 12 is a graph showing a relationship between a thickness of plating and a rate of change of inductance for a case where Fe-50Ni alloy was used as a magnetic layer.

FIG. 13 is a graph showing a relationship between a thickness of plating and a rate of change of resistance for a case where an Fe-50Ni alloy was used as a magnetic layer.

FIG. 14 is a graph showing a relationship between a thickness of plating and a rate of change of Q factor in a case where Fe-50Ni alloy was used as a magnetic layer.

FIG. 15 is a cross-sectional view showing a state where two air core coils are used.

FIG. 16 is a cross-sectional view schematically showing a configuration of a wire rod for inductor of a second embodiment of the present disclosure.

FIG. 17A is a cross-sectional view of an air-core coil and wire rod for inductor. FIG. 17B is a cross-sectional view of a solenoid for examining an attractive force of an electromagnet.

FIG. 18A is a graph showing a relationship between an electric current and an attractive force in an attractive force examination using the solenoid of FIG. 17, and FIG. 18B is a graph showing a relationship between a film thickness of the magnetic layer and a rate of change of the attractive force.

### DETAILED DESCRIPTION

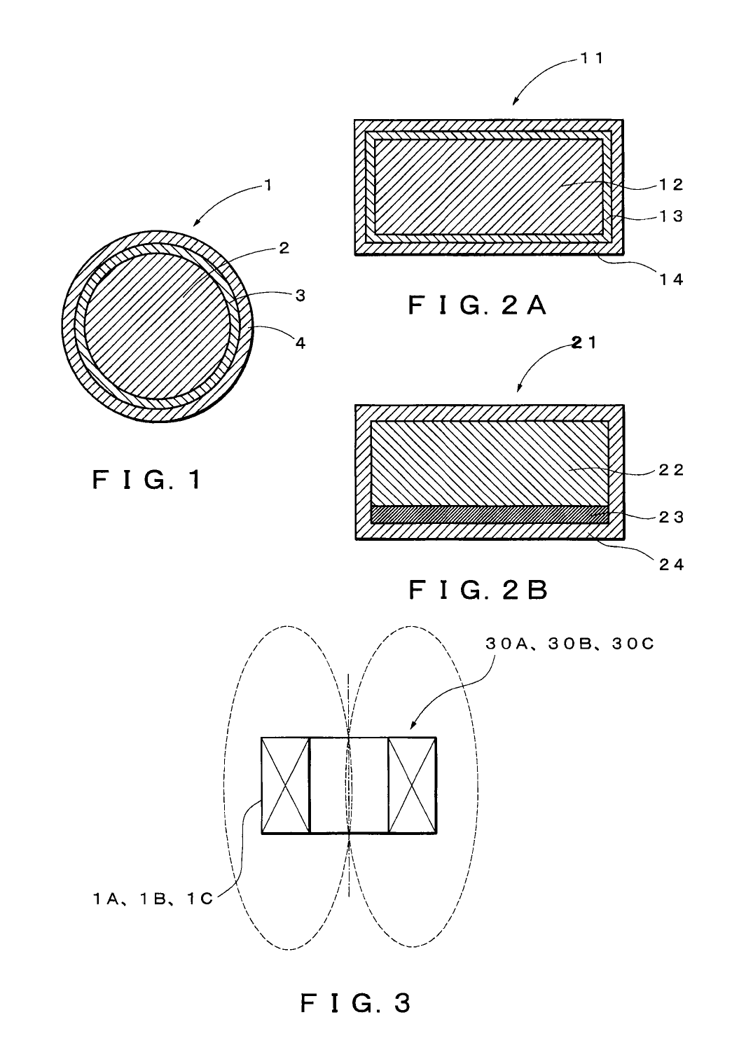

Hereinafter, a wire rod for inductor 1 of an embodiment of the present disclosure will be described with reference to the drawings. FIG. 1 is a cross-sectional view schematically showing a configuration of a wire rod for inductor 1 of a first embodiment of the present disclosure.

The wire rod for inductor 1 includes an electric conductor 2 that is a core of the wire rod, a magnetic layer 3 that covers an outer side of the electric conductor 2 and an insulating layer 4 that covers a further outer periphery of the magnetic layer 3.

The electric conductor 2 has a circular cross-section and is made of copper which is a conductive material.

The magnetic layer 3 is conductive and formed to have a thickness of an order of a few to several μm, and, for example, formed to have a thickness of greater than 0 μm and less than or equal to 3.0 μm. The magnetic layer 3 is formed by a plating or the like in such a manner that it uniformly covers an entire outer periphery of the electric conductor 2. Regarding the material of the magnetic layer 3, the magnetic layer 3 is made of an alloy of two or more elements containing Fe of greater than or equal to 10% by weight. Preferably, the magnetic layer 3 is made of an Fe-50Ni alloy or an Fe-80Ni alloy.

The insulating layer 4 is, for example, an enamel insulating layer, and has a thickness of approximately 35 μm.

As shown in FIGS. 2A and 2B, the wire rod for inductor can be configured as a flat rectangular wire.

A wire rod for inductor 11 shown in FIG. 2A includes an electric conductor 12, that is a core of the wire rod, having a rectangular cross-section and a magnetic layer 13 formed to cover an outer side in its entirety on four sides thereof. Also, an insulating layer 14 is formed outwardly of the magnetic layer 13 to cover an outer side in its entirety of the magnetic layer 13. Such a flat rectangular wire is advantageous in that it can prevent gaps from being produced between adjacent wire rods when winding the wire rod around the core.

A wire rod for inductor 21 shown in FIG. 2B includes a magnetic layer 23 that is formed only at a position below a bottom side of the electric conductor 22 having a rectangular cross-section. An insulating layer 24 is formed to cover them on an outer side.

Now, an experiment of an inductor using the wire rod for inductor 1 of the present embodiment will be described with reference to FIGS. 3 to 14. This example is an experimental verification of a change in inductance of the inductor when a material and a film thickness of the magnetic layer of the wire rod for inductor 1 are changed.

In the related art, as a wire rod for inductor, a wire rod that has only an insulating layer on an outer side of an electric conductor has been used. It is known that, by plating the magnetic layer, an inductance Ls increases for a high frequency band, but a relationship with respect to the resistance value Rs of the wire rod is not known. On the other hand, in this experiment, as a result of measuring an inductance Ls and a resistance value Rs of the wire rod in terms of a material and a thickness of the magnetic layer, it was found that there is an optimum value in a relationship between them.

In this experiment, the following three types of wire rods for inductor were used.

(A) Wire rod for inductor 1A (wire size φ0.5)

Electric conductor: Mainly copper.

Magnetic layer: Alloy of mainly Fe.

Insulating enamel layer (35 μm) outwardly of the magnetic layer.

(B) Wire rod for inductor 1B (wire size φ0.5)

Electric conductor: Mainly copper.

Magnetic layer: Fe-50Ni with heat treatment.

Insulating enamel layer (35 μm) outwardly of the magnetic layer.

(C) Wire rod for inductor 1C (wire size φ0.5)

Electric conductor: Mainly copper.

Magnetic layer: Fe-80Ni without heat treatment.

Insulating enamel layer (35 μm) outwardly of the magnetic layer.

Note that in the description below, alphabets A, B and C accompanying the numerals correspond to the aforementioned wire rods for inductor (A), (B) and (C), respectively.

Initial permeabilities of the wire rods for inductor 1A, 1B and 1C were 100, 2,000 and 500, respectively, expressed in relative permeability.

Saturation flux densities (T) of the wire rods for inductor 1A, 1B, and 1C were 2.0 (T), 1.5 (T) and 0.75 (T), respectively.

As shown in FIG. 3, an air core coil 30A used in this experiment is the wire rod for inductor 1A wound in a cylindrical shape and has nothing in a cylinder. The air core coil 30A has a diameter of φ6 mm and has a number of turns of 17 turns.

Similarly, the air core coils 30B and 30C have the same basic structure and the only difference is their wire rods (material of the magnetic layer).

With such a configuration, first, an experiment on the relationship between a frequency of a usable band and an inductance was carried out for a case where a thickness of plating was 3 μm.

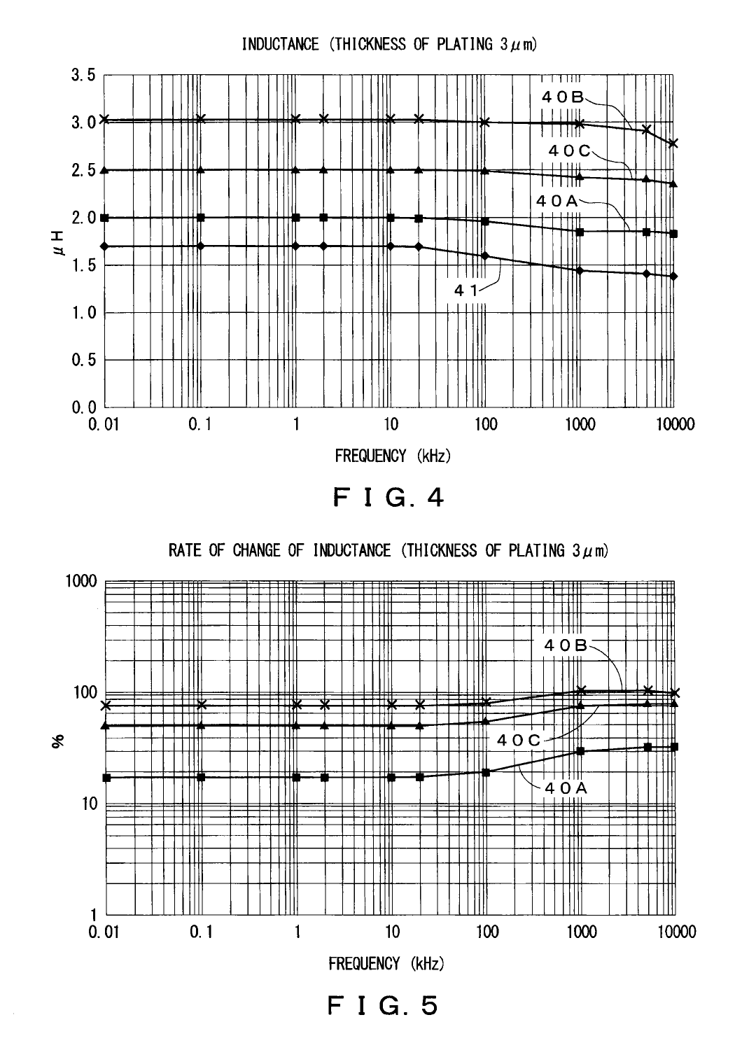

FIG. 4 is a graph showing a relationship between a frequency and an inductance of the air core coil. FIG. 5 is a graph showing a relationship between a frequency and a rate of change of inductance of the air core coil. In these graphs, reference numeral 40A indicates measurement values for an air core coil 30A using the wire rod for inductor 1A (thickness of plating 3 μm), reference numeral 40B indicates measurement values for the air core coil 30B and reference numeral 40C indicates measurement values for the air core coil 30C. Reference numeral 41 indicates measurement values for an air core coil constituted by a wire rod provided with no magnetic layer (note that, in FIG. 5, the measurement values for reference numeral 41 are omitted since the rate of change is 0% for any frequency).

From the results of the experiments shown in FIGS. 4 and 5, the followings can be determined.

(a) As shown in FIG. 4, the air core coils 30A, 30B and 30C using the wire rods for inductor 1A, 1B and 1C (reference numeral 40A, 40B and 40C) have inductances that are higher than that of the wire rod provided with no magnetic layer (reference numeral 41), for an entire range of the frequency band 0.01 kHz to 10,000 kHz. Thereby, it can be determined that, by providing the magnetic layer 3 consisting of an alloy of two or more elements which contains Fe of greater than or equal to 10% by weight, the inductances for the wire rods for inductor 1A, 1B and 1C improves.

Particularly, it was found that the wire rod 1B provided with an Fe-50Ni alloy (air core coil 30B, shown by reference numeral 40B) takes the highest values in the aforementioned entire frequency band (e.g., at a frequency of 1,000 kHz, an inductance of approximately double the reference numeral 41).

With the wire rod for inductance 1C (air core coil 30C, shown by reference numeral 40C) which is provided with an Fe-80Ni alloy, an inductance of a multiple of approximately 1.7 is obtained, for example, in comparison to reference numeral 41 at frequency 1,000 kHz.

(b) As shown in FIG. 5, the air core coils 30A, 30B and 30C using the wire rods for inductor 1A, 1B and 1C (reference numeral 40A, 40B and 40C) show an improvement in a rate of change of inductance (a rate of change with respect to an air core coil that uses a wire rod that is provided with no magnetic layer) in an entire range of the frequency band 0.01 kHz to 10,000 kHz.

Particularly, it was found that in all of the air core coils 30A, 30B and 30C, the rate of change of inductance improved in a frequency band of greater than or equal to 1,000 kHz than in a frequency band of less than or equal to 1,000 kHz. Accordingly, it can be determined that, at a high frequency band, a high inductance can be obtained by providing a magnetic layer.

Then, a change in the inductance and a change in the resistance value were measured for the aforementioned air core coils 30A, 30B and 30C for cases where the film thickness (thickness of plating) of the magnetic layer 3 was changed between 1.0 μm, 3.0 μm and 5.0 μm. Since the changes in the inductance and the resistance value vary depending on the frequency band, measurements were taken with the value of frequency being 0.01 kHz, 0.1 kHz, 1 kHz, 2 kHz, 10 kHz, 20 kHz, 100 kHz, 1,000 kHz, and 5,000 kHz. Note that a current density is 5 A/mm².

Then, from these measurement values, the respective Q factors were calculated.

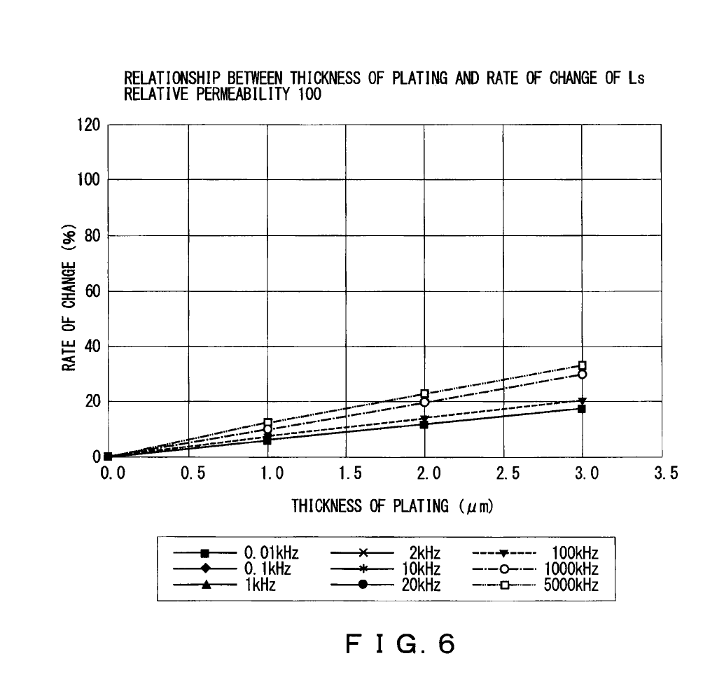

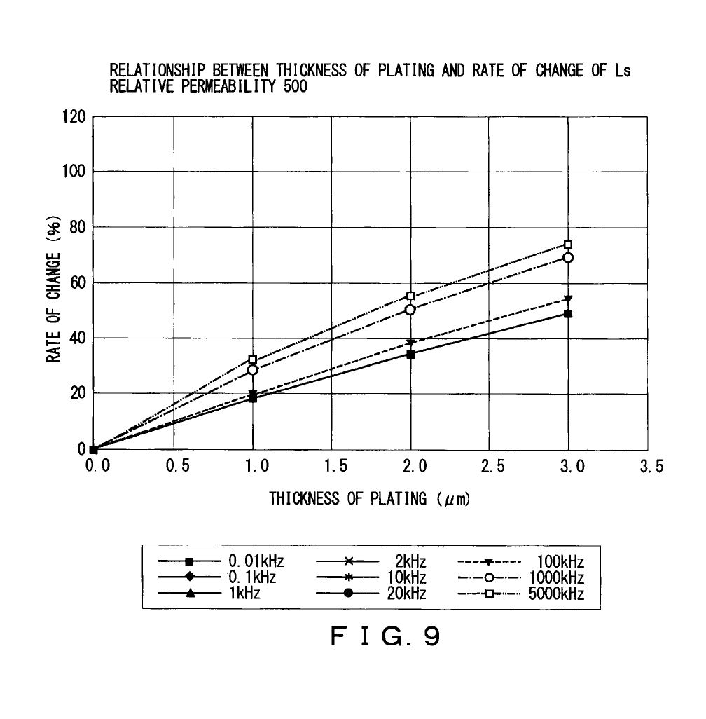

Each of FIGS. 6 to 8 shows a relationship between each of an inductance, a resistance value and a Q factor with respect to the thickness of plating for the air core coil 30A. Note that, in FIGS. 6 to 8 (same for FIGS. 9 to 14), data are measured for each of the aforementioned frequencies, and a polygonal line graph is created for each frequency (the frequencies are indicated at the bottom of the graph).

It can be seen from the graph of FIG. 6 that, for all frequency bands, the inductance Ls increases as the thickness of plating is increased from 1.0 μm to 3.0 μm.

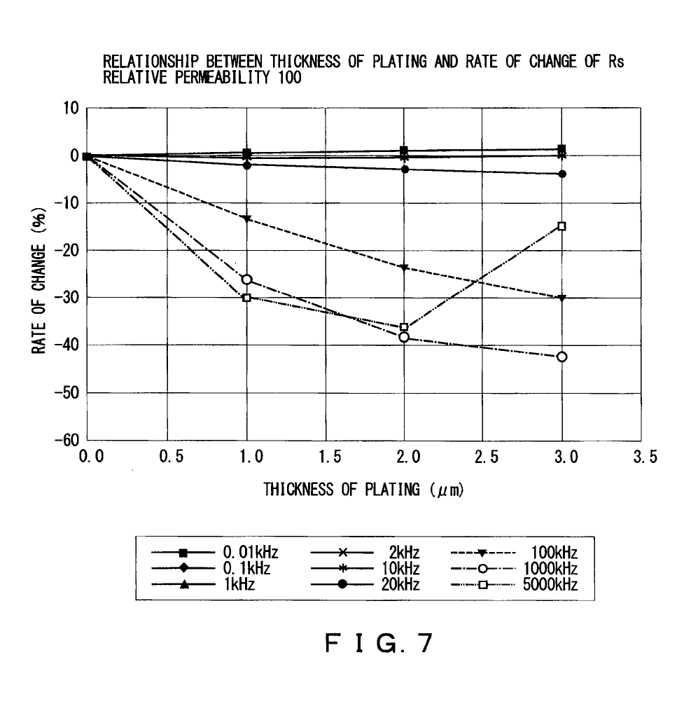

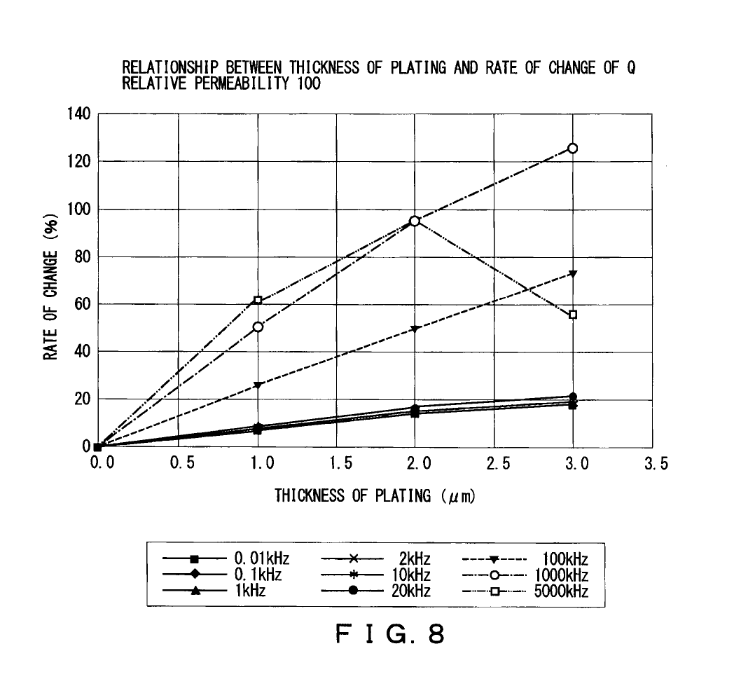

However, regarding the resistance value R, as shown in FIG. 7, it was found that, in a case where the frequency band is 5,000 kHz, the resistance value R decreases as the thickness of plating increases from 1.0 μm to 2.0 μm, and that the resistance value R increases as the thickness of plating increases from 2.0 μm to 3.0 μm. Regarding the Q factor, as shown in FIG. 8, it was found that the Q factor increases as the thickness of plating increases from 1.0 μm to 2.0 μm, and the Q factor decreases as the thickness of plating increases from 2.0 μm to 3.0 μm. In other words, in a section where there is a decrease in the Q factor, the Q factor has decreased since the increase in the resistance value R was greater than the increase in the inductance Ls.

Accordingly, in order to increase the Q factor of the air core coil 30A, first, in a frequency band in which the air core coil 30A is used, it is preferable to provide the thickness of plating such that the resistance value Rs decreases by a predetermined amount with respect to a case where plating is not provided. Furthermore, it is still preferable to provide a thickness of plating to be such that the resistance value Rs is around a smallest value (or a minimum value).

Further, it can be seen that, when distinguishing between the frequency bands, in the case of the air core coil 30A used in a frequency band of greater than or equal to 5,000 kHz, it is preferable to make a thickness of the plating to be approximately 2.0 μm (greater than 1 μm and less than 3 μm).

FIGS. 9 to 11 show relationships between an inductance, a resistance value and a Q factor with respect to a thickness of plating, respectively, for the air core coil 30C.

It can be seen from the graph of FIG. 9, that for all frequency bands, the inductance Ls increases as the thickness of plating is increased from 1.0 μm to 3.0 μm.

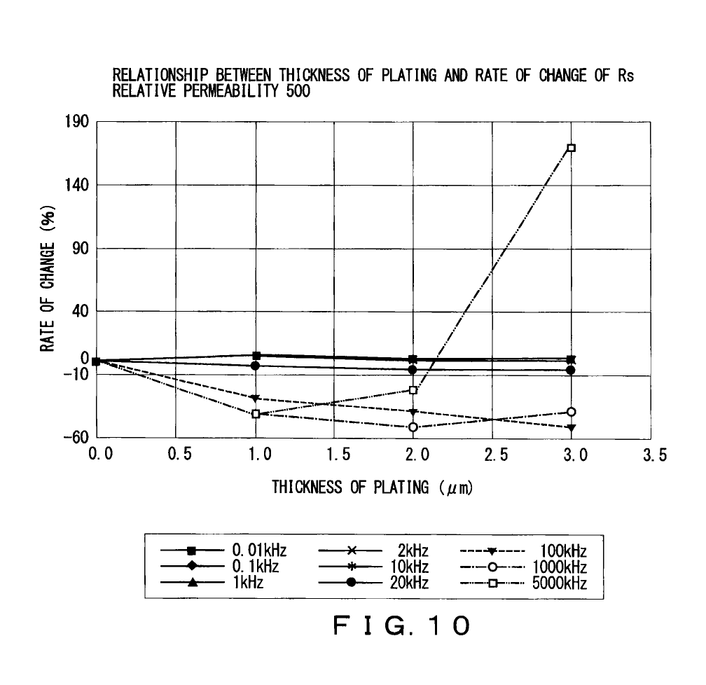

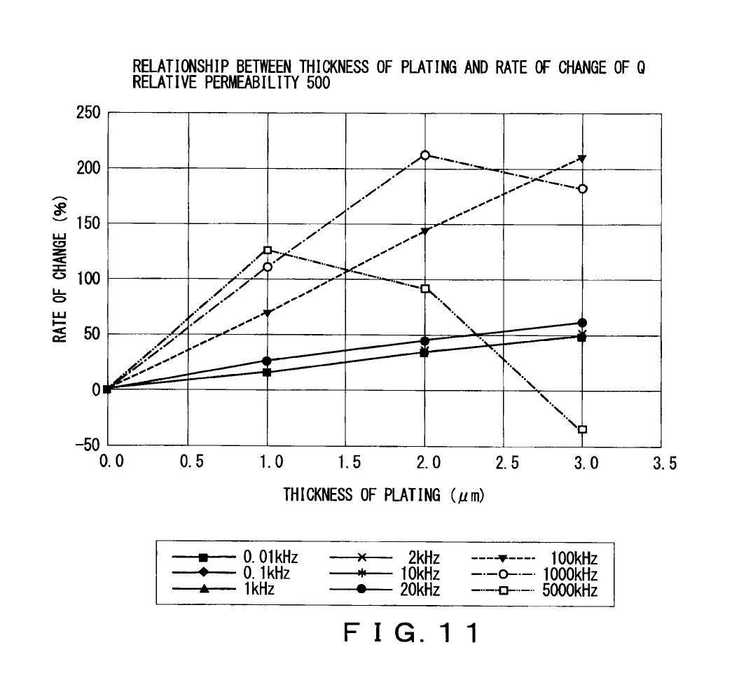

However, regarding the resistance value R, as shown in FIG. 10, it was found that, in the case where the frequency band is 1,000 kHz, the resistance value R decreases as the thickness of plating increases from 1.0 μm to 2.0 μm, and that the resistance value R increases as the thickness of plating increases from 2.0 μm to 3.0 μm. Regarding the Q factor, as shown in FIG. 11, it was found that the Q factor increases as the thickness of plating increases from 1.0 μm to 2.0 μm, and the Q factor decreases as the thickness of plating increases from 2.0 μm to 3.0 μm. In other words, in a section where the Q factor decreases, the Q factor decreases since an increase in the resistance value R is greater than an increase in the inductance Ls.

Similarly, when viewing in a similar manner for the case where the frequency band is 5,000 kHz, as shown in FIG. 11, regarding the Q factor, it was found that the Q factor increases as a thickness of the plating increase from 0 μm (does not include 0 μm) to 1.0 μm and that the Q factor decreases as the thickness of plating increases from 1.0 μm to 2.0 μm.

Accordingly, it is can be seen that in the case of increasing the Q factor of the air core coil 30C, it is first necessary to distinguish between the frequency bands. In other words, in the case of the air core coil 30C used in the frequency band of 1,000 kHz (greater than 100 kHz and less than 5,000 kHz), it is preferable to make a thickness of the plating to be approximately 2.0 (greater than 1 μm and less than 3 μm). Also, in the case of the air core coil 30C used in the band of greater than or equal to 5,000 kHz, it can be seen that it is preferable to make the thickness of the plating to be 1 μm (greater than 0 μm and less than 2 μm).

Further, from the aforementioned measurement results of 1,000 kHz and 5,000 kHz, it can be seen that the Q factor can be maximized (optimized) by reducing the thickness of the magnetic layer 3 as the usable frequency band becomes greater. Further, in the present measurement result, although the greatest value of the Q factor does not appear in the band of less than or equal to 1,000 kHz, it is estimated that the aforementioned relationship between the magnitude of frequency band and the thickness of magnetic layer 3 holds.

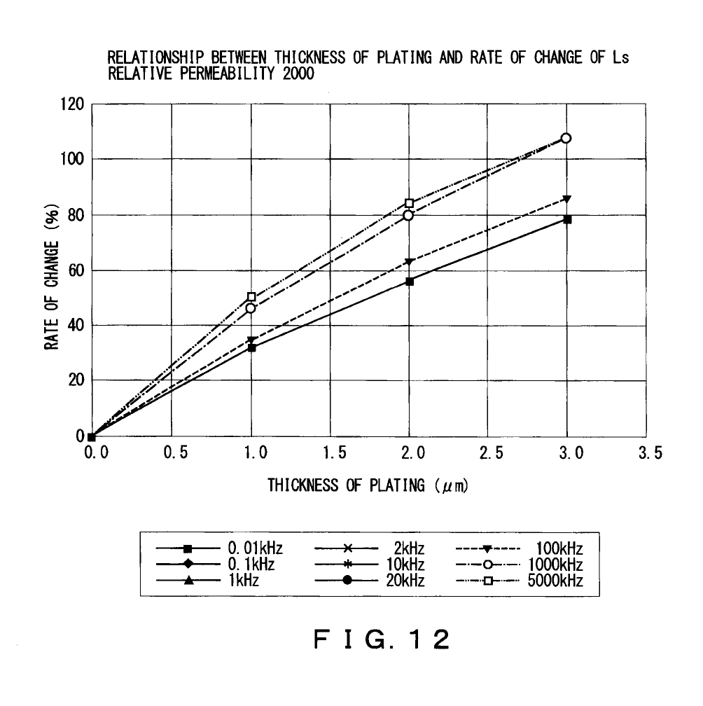

FIGS. 12 to 14 show relationships between an inductance, a resistance value and a Q factor, respectively, with respect to the thickness of plating, for the air core coil 30B.

From the graph of FIG. 12, it can be seen that, for all frequency bands, the inductance Ls increases as the thickness of plating is increased from 1.0 μm to 3.0 μm.

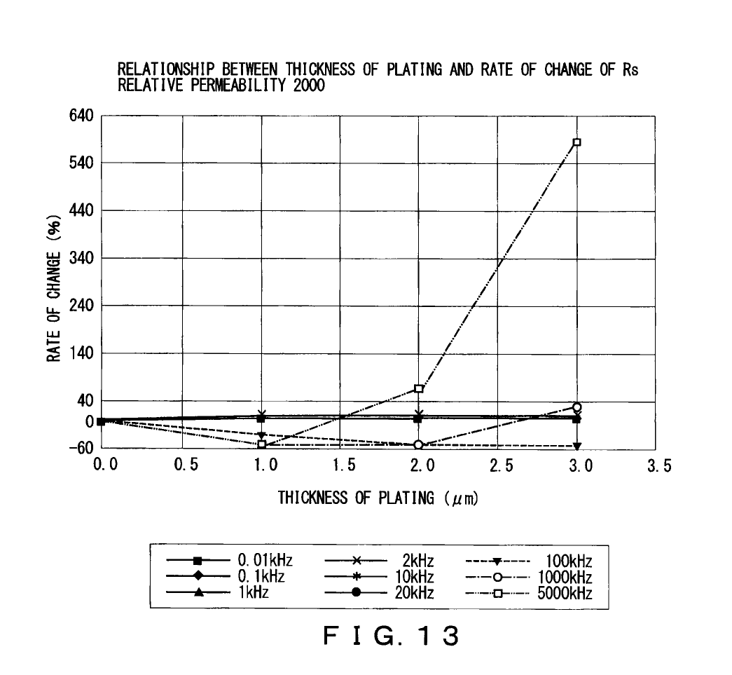

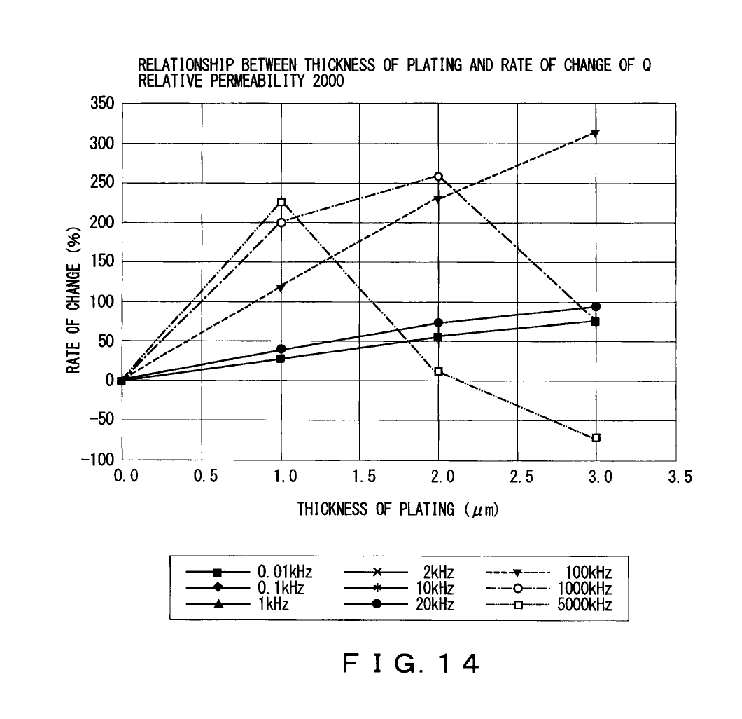

However, regarding the resistance value R, as shown in FIG. 13, it was found that, in a case where the frequency band is 1,000 kHz (data plotted with white circular dots), the resistance value R slightly increases as the thickness of plating increases from 1.0 μm to 2.0 μm, and that the resistance value R increases as the thickness of plating increases from 2.0 μm to 3.0 μm. Regarding the Q factor, as shown in FIG. 14, it was found that the Q factor increases as the thickness of plating increases from 1.0 μm to 2.0 μm, and the Q factor decreases as the thickness of plating increases from 2.0 μm to 3.0 μm. In other words, in a section where the Q factor decreases, the Q factor decreases since an increase in the resistance value R is greater than an increase in the inductance Ls.

Similarly, when viewing in a similar manner for the case where the frequency band is 5,000 kHz, as shown in FIG. 14, regarding the Q factor, it was found that the Q factor increases as a thickness of the plating increase from 0 urn (does not include 0 μm) to 1.0 μm, and that the Q factor decreases as the thickness of plating increases from 1.0 μm to 2.0 μm.

Accordingly, it is can be seen that in the case of increasing the Q factor of the air core coil 30B, it is first necessary to distinguish between the frequency bands. In other words, in the case of the air core coil 30B used in the frequency band of 1,000 kHz (greater than 100 kHz and less than 5,000 kHz), it is preferable to make a thickness of the plating to be approximately 2.0 μm (greater than 1 μm and less than 3 μm). Also, in the case of the air core coil 30B used in the band of greater than or equal to 5,000 kHz, it can be seen that it is preferable to make the thickness of the plating to be 1 μm (greater than 0 μm and less than 2 μm).

Further, from the aforementioned measurement results for 1,000 kHz and 5,000 kHz, it can be determined that the Q factor can be maximized (optimized) by reducing the thickness of the magnetic layer 3 as the usable frequency band increases. Further, in the present measurement result, although the greatest value of the Q factor does not appear in the band of less than or equal to 1,000 kHz, it is estimated that the aforementioned relationship between the magnitude of frequency band and the thickness of magnetic layer 3 holds.

Focusing on the relative permeability, from the results of FIGS. 8 and 11, it can be seen that, in a case where the relative permeability is 100 to 500, a good Q factor can be obtained with the frequency band of greater than or equal to 0.01 kHz and less than or equal to 1,000 kHz when the thickness of plating is greater than 0 μm and less than or equal to 3.0 μm, and more preferably, greater than or equal to 0.5 μm and less than or equal to 3.0 μm. Also, it can be seen that, in the relative permeability of the same range, a good Q factor can be obtained with the frequency band of greater than or equal to 0.01 kHz and less than or equal to 5,000 kHz when the thickness of plating is greater than 0 μm and less than or equal to 2.0 μm, and more preferably, greater than or equal to 0.5 μm and less than or equal to 2.0 μm.

It can be seen that, in a case where the relative permeability is 500 to 2,000, a good Q factor can be obtained with the frequency band of 0.01 kHz to 1,000 kHz when the thickness of plating is greater than 0 μm and less than or equal to 2.5 μm, and more preferably, greater than or equal to 0.5 μm and less than or equal to 2.0 μm (FIG. 11, FIG. 14). Also, it can be seen that, in the relative permeability of the same range, a good Q factor can be obtained with the frequency band of greater than or equal to 0.01 kHz and less than or equal to 1,000 kHz when the thickness of plating is greater than 0 μm and less than or equal to 2.0 μm, and more preferably, greater than or equal to 0.5 μm and less than or equal to 2.0 μm. Further, it can be seen that, in the relative permeability of the same range, a good Q factor can be obtained with the frequency band of greater than or equal to 0.01 kHz and less than or equal to 5,000 kHz when the thickness of plating is 0.5 μm to 1.5 μm.

According to the wire rod for inductor of the embodiment of the present disclosure, since the wire rod for inductor 1 (11, 21) used for a coil 30A, 30B, 30C of an inductor includes a magnetic layer 3 (13, 23) having a thickness of greater than 0 μm and less than or equal to 3.0 μm that is provided on a surface of the electric conductor 2 (12, 22), an inductance Ls of the coil 30A, 30B, 30C can be increased while decreasing the resistance value R, and an Q factor can be improved as compared to a case of a wire rod provided with no magnetic layer 3 (13, 23).

The magnetic layer 3 (13, 23) is made of an alloy of two or more elements containing Fe of greater than or equal to 10% by weight, specifically, an Fe-50Ni alloy or an Fe-80Ni alloy, the magnetic layer 3 (13, 23) can be easily formed by plating or the like.

On the other hand, since the thickness of the magnetic layer 3 (13, 23) of an Fe-50Ni alloy or an Fe-80Ni alloy is decreased as the usable frequency band increases, it is possible to achieve a high Q factor by taking an increase in the inductance Ls and an increase or a decrease in the resistance R into consideration. That is to say, an optimum Q factor can be realized.

Also, in a case where the usable frequency band is greater than or equal to 5,000 kHz, since the thickness of the magnetic layer of an alloy of two or more elements containing Fe of greater than or equal to 10% by weight is made to be greater than 1 μm and less than 3 μm, it is possible to achieve a high Q factor by taking an increase in the inductance Ls and an increase or a decrease in the resistance R into consideration.

Further, in a case where the usable frequency band is greater than 100 kHz and less than 5,000 kHz, since the thickness of the magnetic layer 3 (13, 23) of an Fe-50Ni alloy or an Fe-80Ni alloy is made to be greater than 1 μm and less than 3 μm, it is possible to achieve a high Q factor by taking an increase in the inductance Ls and an increase or a decrease in the resistance R into consideration.

Further, in a case where the usable frequency band is greater than or equal to 5,000 kHz, since the thickness of the magnetic layer 3 (13, 23) of an Fe-50Ni alloy or an Fe-80Ni alloy is made to be greater than 0 μm and less than 2 μm, it is possible to achieve a high Q factor by taking an increase in the inductance Ls and an increase or a decrease in the resistance R into consideration.

Also, considering FIGS. 6 to 14 from the value of the relative permeability, within a range where the relative permeability is around 100 to 2,000, by making the thickness of plating to be 0.5 to 3.0 μm, an inductor having a good Q factor in the frequency band of around 100 kHz to 5,000 kHz, especially around 100 kHz to 1,000 kHz can be obtained.

Within the range of the aforementioned relative permeability, by making this value to a lower value (around 100 to 500), a wire rod for inductor having a low rate of increase of Q factor but a high Q factor at a frequency of up to around 5,000 kHz can be obtained within a relatively broad range of thickness of plating of around 0.5 to 2.5 μm.

Also, when this value is made high (around 500 to 2,000), a very high Q factor can be obtained at a frequency of up to around 5,000 kHz in a range of the thickness of plating of 0.5 to 1.5 μm. By making the frequency band to be up to around 1,000 kHz, an even higher Q factor can be obtained with a thickness of plating of 0.5 to 3.0 μm.

In such cases, since the magnetic layer 3 (13) is provided between the electric conductor 2 (12) and the insulating layer 4 (14), the magnetic layer 3 (13) can be easily formed by plating on the electric conductor 2 (12) made of copper.

Also, by manufacturing the inductor using the aforementioned wire rod for inductors 1, 11, 21, it is possible to achieve a high Q factor by taking an increase in the inductance Ls and an increase or a decrease in the resistance R into consideration.

The wire rod for inductor 1 (11, 21) of the embodiment of the present embodiment has been described above. However, the present disclosure is not limited to the aforementioned embodiments, and various modifications and alterations can be made based on a technical spirit of the present invention.

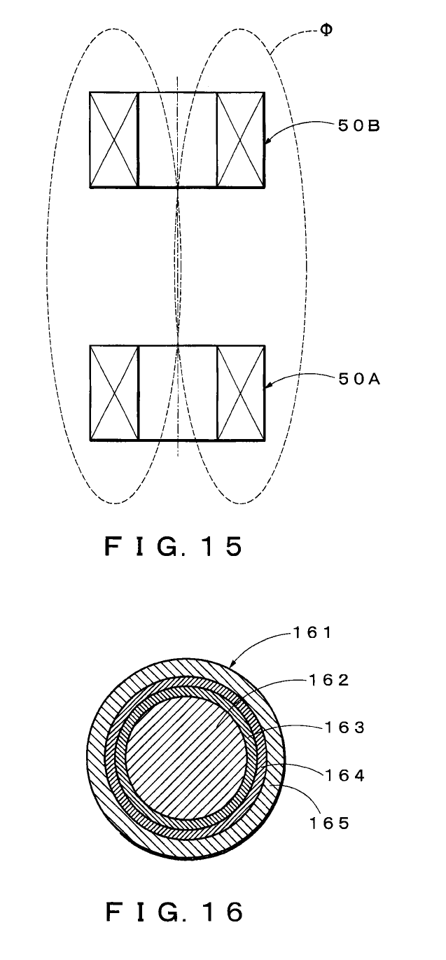

For example, in an experimental example of the air core coils 30A, 30B and 30C, data are measured using a single air core coil. However, as an applied example, as shown in FIG. 15, for example, like a transformer, an electric power transmitted using two air core coils 50 (a receiver coil 50A and a transmitter coil 50B) can be increased.

When a voltage E was applied across the transmitter coil 50B, an electric current I₂ flowing through the receiver coil 50A can be expressed as:

I₂=E×jwM/((R₁+jwL₁)(R₂+jwL₂)+(wM)²),
where
L₁: Inductance of transmitter coil 50B;
R₁: Resistance of transmitter coil 50B (sum of direct-current resistance and alternating-current resistance);
L2: Inductance of receiver coil 50A;
R2: Resistance of receiver coil 50A (sum of direct-current resistance and alternating-current resistance);
w: Angular frequency of an electric current flowing through the coil 50B; and
M: Mutual inductance of L₁ and L₂

An electromotive force E₂ of the receiver coil 50A can be expressed as:

E₂=−jwM.

Thus, a transmission power W can be expressed as:

W=E₂I₂=(wM)²/((R₁+jwL₁)(R₂+jwL₂)+(wM)²).

Since Q₁=wL₁/R₁ Q₂=wL₂/R₂,

a component of the denominator can be expressed as:

(R₁+jwL₁)(R₂+jwL₂)=(1/wQ₁L₂+jL₁/wL₂)(1/wQ₂L₁+jL₂/wL₁).

That is to say, the electric power W to be transmitted can be increased by increasing the Q factor (Q1, Q2) of the aforementioned equation.

Note that the aforementioned embodiment is shown by way of example, and in addition, it is also applicable to an antenna coil, signals utilizing electromagnetic induction and magnetic resonance, or an electric power transmission coil, and enables an efficient signal and electric power transmission.

In the first embodiment described above, the magnetic layer 3 (13, 23) made of an alloy containing a predetermined amount of Fe metal was taken as an example. In addition, the inventors have found that an attractive force can be increased in a case where the magnetic layer is made of Fe alone as compared to a case where the wire rod for inductor is provided with no magnetic layer.

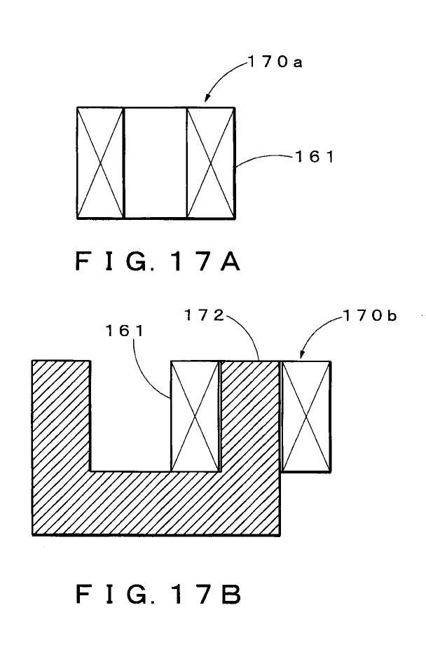

FIG. 16 is a cross-sectional view schematically showing a configuration of a wire rod for inductor of a second embodiment of the present disclosure. Since the configuration of the wire rod for electromagnet of the present embodiment is basically the same as the configuration of the wire rod for inductor of the first embodiment, different parts will be described below.

A wire rod for inductor 161 includes an electric conductor 162 which is a core of the wire rod, a magnetic layer 163 that covers an outer side of the electric conductor 162, a metal layer 164 that covers a further outer periphery of the magnetic layer 163, and an insulating layer 165 that covers a further outer periphery of the metal layer 164. In other words, the magnetic layer 163 is provided between the electric conductor 162 and the metal layer 164. In this embodiment, a wire size of the wire rod for inductor 161 is, for example, φ0.5.

The magnetic layer 163 is made of a magnetic layer which is a film made of Fe (single element). The film thickness of the magnetic layer is greater than 0 μm and less than or equal to 3.0 μm and preferably greater than or equal to 1.5 μm and less than or equal to 3.0 μm. The metal layer 164 is preferably formed with a thickness of an order of several μm, and, for example, made of Ni.

FIGS. 17A and 17B are sectional views of the coil using the wire rod for inductor. As shown in FIG. 17A, an air-core coil 170a of the present embodiment is constituted by winding up the wire rod for inductor 161 having a magnetic layer (thickness 3 am) made of Fe into in a cylindrical shape with nothing in the cylinder. The air-core coil 170a has a diameter of φ25 mm and a number of turns of 150 turns. FIG. 17B shows a coil 170b formed by disposing a core 172 of a ferrite core 171 having a substantially U-shaped cross section inside the cylinder of the air-core coil 170a.

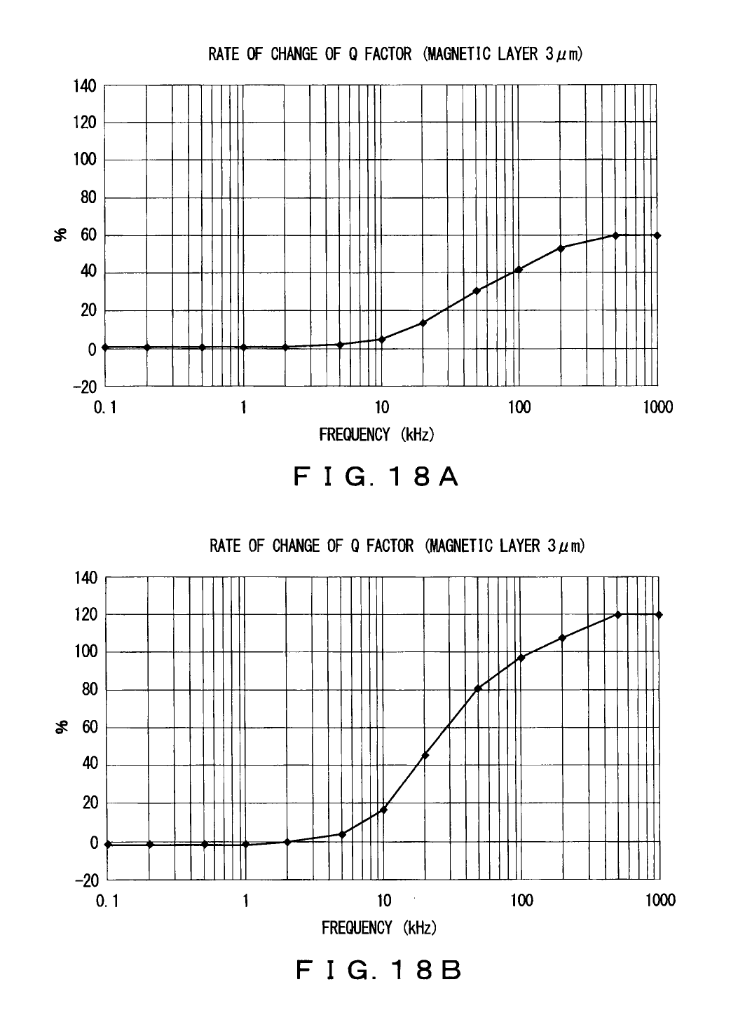

FIGS. 18A and 18B are diagrams showing a relationship between a frequency and a rate of change of the Q factor for the coils shown in FIGS. 17A and 17B, respectively. From the graph of FIG. 18A, it can be seen that, in the case of the air-core coil 170a, the rate of change of Q factor increases as the frequency increases at the frequency of greater than or equal to approximately 2 kHz and or less than or equal to approximately 500 kHz. Also, it can be seen that the rate of change of Q factor increased by approximately 40% at a frequency of 100 kHz, and that the rate of change of Q factor increased by approximately 60% at a frequency of 500 kHz.

From the graph of FIG. 18B, it can be seen that, in the case of the coil 170b using a ferrite core, the rate of change of Q factor increases as the frequency increases at the frequency of greater than or equal to approximately 2 kHz and or less than or equal to approximately 500 kHz. Also, it can be seen that the rate of change Q factor is approximately 80% at the frequency of 50 kHz, that the rate of change Q factor is approximately 97% at the frequency of 100 kHz, and that the rate of change Q factor increases by approximately 120% at the frequency of 500 kHz. Further, it can be seen that at the frequency within the range of greater than or equal to approximately 5 kHz and less than or equal to approximately 500 kHz, the Q factor of the coil 170b using the ferrite core shows a value that is greater than or equal to double the Q factor of the air-core coil for any frequency.

With the wire rod for inductor according to the present embodiment, since the magnetic layer 163 is formed by a layer made of Fe, the Q factor of the air-core coil 170a can be increases as compared to a case in which the magnetic layer 163 is not provided. In the case of the coil 170b in which the ferrite core is used, a high Q factor that is greater than or equal to double the Q factor of the air-core coil 170a can be achieved in the aforementioned frequency band.

In the present embodiment, the magnetic layer 163 is made of Fe. However, it is not limited thereto, and may be made of substantially Fe. An effect similar to the above can be achieved with the present configuration.

In the present embodiment, Fe only, an alloy mainly containing Fe or an Fe—Ni alloy was used for forming the magnetic layer. However, it is not limited thereto, and any material can be used as long as a magnetic substance can be made.

What is claimed is:

1. A wire rod for inductor used for a coil of an inductor, comprising:
an electric conductor; and
a magnetic layer made of Fe that is provided on a surface of the electric conductor,
the magnetic layer having a thickness of greater than 0 μm and less than or equal to 3.0 μm.

2. The wire rod for inductor according claim 1, wherein a usable frequency band is greater than or equal to 0.01 kHz and less than or equal to 1,000 kHz.

3. The wire rod for inductor according claim 1, wherein the magnetic layer has a thickness of greater than or equal to 1.5 μm and less than or equal to 3.0 μm.

4. The wire rod for inductor according to claim 1, wherein the magnetic layer is provided between the electric conductor and an insulating layer.

5. The wire rod for inductor according to claim 1, wherein the magnetic layer is formed on a surface of the electric conductor by plating.

6. The wire rod for inductor according to claim 1, wherein the electric conductor has a substantially rectangular cross section.

7. An inductor using a wire rod for inductor according to claim 1.

8. A wire rod for inductor used for a coil of an inductor, comprising:
an electric conductor; and
a magnetic layer provided on a surface of the electric conductor,
the magnetic layer having a thickness of greater than 0 μm and less than or equal to 3.0 μm, the magnetic layer being an alloy of two or more elements containing Fe of greater than or equal to 10% by weight.
